(19) United States
(12) Patent Application Publication
(10) Pub. No.: US 2004/0189952 A1
(43) Pub. Date: Sep. 30, 2004

(54) Projection display

(75) Inventor: Yasunori Kuratomi, Seongnam-si (JP)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/721,760

(22) Filed: Nov. 26, 2003

(30) Foreign Application Priority Data
Mar. 25, 2003 (KR) 2003-18499

(51) Int. Cl. G03B 21/00

(52) U.S. Cl. 353/31

(57) ABSTRACT

A projection display includes an illumination module, an optical modulator for modulating light incident from the illumination module in response to image data, and a projection optical system for projecting light emitted from the optical modulator on an enlarged scale. The illumination module includes at least one light source, and a light recycling unit which causes light emitted from the light source having an emission angle beyond a predetermined range in which light can be effectively projected by the projection optical system to travel within the predetermined range.

### BACKGROUND OF THE INVENTION

This application claims the priority of Korean Patent Application No. 2003-18499, filed on Mar. 25, 2003, in the Korean Intellectual Property Office, the disclosure of which is incorporated herein in its entirety by reference.

1. Field of the Invention

The present invention relates to a projection display that projects an enlarged image onto a screen.

2. Description of the Related Art

In recent years, projection displays that project an enlarged image, modulated by an optical modulator such as a liquid crystal panel, onto a screen have become popular.

FIG. 1 is a schematic diagram illustrating the configuration of a conventional projection display.

Referring to FIG. 1, a conventional projection display comprises liquid crystal panels 20R, 20G, and 20B which are optical modulators, an illumination module 10 for providing light to the liquid crystal panels 20R, 20G, and 20B, and a projection lens 40 for projecting a modulated image on an enlarged scale.

The projection display includes three liquid crystal panels 20R, 20G and 20B corresponding to red (R), green (G), and blue (B) images, respectively. A synthesis prism 30 synthesizes light which has been modulated by the liquid crystal panels 20R, 20G,. and 20B, to respectively correspond to the colored images, and radiates the light to the projection lens 40.

The illumination module 10 includes a light source 1, an integrator 3, a condenser lens 4, a plurality of mirrors 5R, 5G, 5B, and 6, and a plurality of relay lenses 7 and 8.

A metal halide lamp, a high pressure mercury lamp, or the like, is used as the light source 1. The light source 1 is positioned at a focal point of a reflecting mirror 2 having a parabolic surface to provide parallel light. The integrator 3 is used to uniformly illuminate the liquid crystal panels 20R, 20G, and 20B. Typically, two fly-eye lenses, which are formed in a two-dimensional micro lens array, are used as integrator 3. Light which has passed through the integrator 3 is focused by the condenser lens 4. The mirrors 5R, 5G and 5B are selective reflecting mirrors which reflect red, green, and blue light, respectively, and transmit other colors of light. Thereby, light is divided into red, green, and blue components while passing through the mirrors 5R, 5G, and 5B. The red, green, and blue components then pass through relay lenses 7 and 8, and are incident on the liquid crystal panels 20R, 20G, and 20B, respectively. The liquid crystal panels 20R, 20G, and 20B modulate the incident light and output red, green, and blue images. The images are then synthesized by the synthesis prism 30 and projected, on an enlarged scale, through projection lens 40.

The life span of a lamp used as the light source of the conventional projection display is several thousand hours at the longest. Therefore, one drawback is that when the conventional projection display is used frequently, the lamp must be replaced often. Another drawback of the conventional projection display is that the illumination module is quite large.

To solve these problems, Japanese Patent Laid-open Publication No. 2001-42431 uses a light emitting diode (LED) to lengthen the life span of the light source. Disadvantageously, however, when an LED is used as a light source, light-collecting efficiency deteriorates due to the limitations of an illumination optical system using lenses. This will be explained in further detail with reference to FIGS. 2A and 2B.

A value obtained by multiplying an image's size by its angle is conserved in a paraxial area. Thus, a value obtained by multiplying the area of light emitted from LED by the steradian of light emitted is a conserved quantity, called etendue. When the conserved quantity is smaller than a value obtained by multiplying the area of a liquid crystal panel by the steradian calculated from an F number of a projection lens, light-collecting efficiency is enhanced.

As shown in FIG. 2A, where one LED is used, a value obtained by multiplying the area Φ_{L} by the steradian U_{L} of light emitted from the LED can be the same as a value obtained by multiplying the area Φ_{P} by the steradian Uₚ of light emitted from a liquid crystal panel.

However, since the amount of light emitted is not sufficient with only one LED, Japanese Patent Laid-open Publication No. 2001-42431 discloses an array of LEDs. In this case, the area ΣΦ_{L} of light emitted from the LED array is larger than the area Φ_{L} of light emitted from one LED as shown in FIG. 2B. Here, the steradian U_{L} of light emitted from the LED and the steradian U_{L} of light emitted from the LED array are the same, and the area Φ_{P} of light emitted from the liquid crystal panel in the LED and the area Φ_{P} of light emitted from the liquid crystal panel in the LED array are the same. Therefore, to conserve etendue, a steradian U_{P}, of light emitted from a liquid crystal panel when an LED array is used becomes bigger than a steradian U_{P} in the case of one LED. Accordingly, loss occurs as shown in FIG. 2B, leading to deterioration in light-collecting efficiency. As a result, the brightness of a projection display decreases.

Herein, the light-collecting efficiency does not mean efficiency of simply illuminating an optical modulator. The light-collecting efficiency herein refers to the efficiency of illuminating the optical modulator so that an angle of light output from the optical modulator is within a predetermined range in which the light can be effectively projected by a projection lens.

### SUMMARY OF THE INVENTION

The present invention provides a projection display including a small light source having a long life span and an illumination module having high light-collecting efficiency.

According to one aspect of the present invention, there is provided a projection display comprising: an illumination module; an optical modulator for modulating light incident from the illumination module in response to image data; and a projection optical system for projecting light emitted from the optical modulator on an enlarged scale, wherein the illumination module comprises: at least one light source; and a light recycling unit, which causes light emitted from the light source and having an emission angle beyond a predetermined range in which light can be effectively projected by the projection optical system to be “recycled,” such that it is reflected to travel within the predetermined range.

The light source may comprise a light emitting diode array on which a plurality of light emitting diodes are arranged, or an organic electro-luminescence device.

The light recycling unit may comprise: an integrator for guiding light incident from the light source to the optical modulator and including an optical angle converter which changes a propagation angle of light; and an optical angle selector disposed on an output side of the integrator for selectively transmitting or reflecting light depending on an incident angle of the light.

Herein, the integrator may comprise a light guide in the form of a flat panel which has an angle of total internal reflection, and the light source may be located in such a manner as to project light to at least one edge surface of the light guide. Here, the optical angle converter may comprise a scattering pattern or a diffraction pattern disposed on at least one of a light emitting surface of the light guide and a surface opposite to the light emitting surface.

Further, the light guide may comprise a light tunnel in the form of a hollow rectangular pipe having a light reflecting surface formed at the inner walls thereof, or a light rod in the form of a hollow rectangular pipe made of a transparent material, instead of the light tunnel. In this case, the light source may be located in such a manner as to radiate light to an end of one side of a light tunnel or a light rod. Furthermore, the optical angle converter may be located at an end of the light tunnel or the light rod in such a manner as to be positioned on the opposite side of the light source.

The optical angle selector may comprise a selective transmission member which transmits light emitted from the integrator having an emission angle within a predetermined range in which light can be effectively projected by the projection optical system and which reflects light having an emission angle outside of the predetermined range. The optical angle selector may further comprise a prism sheet on which a pattern of micro prisms, whose apexes are directed toward the optical modulator, is formed. In this case, the prism sheet may be interposed between the integrator and the selective transmission member and the optical angle selector may further comprise an anisotropic diffusion member which is interposed between the integrator and the prism sheet to scatter and transmit light having an incident angle of approximately 0 degrees and only to transmit light incident at other angles.

When the optical modulator is a transmission-type optical device, which permits only light having a predetermined polarization to pass therethrough, the optical angle selector may further comprise a polarization member. The polarization member transmits only light having a polarization which can pass through the optical modulator and reflects other polarizations. Here, the polarization member may be located on an output side of the selective transmission member.

Here, the optical angle selector may comprise a prism sheet on which a pattern of micro prisms, whose apexes are directed to the optical modulator, is formed. The optical angle selector may further include an anisotropic diffusion member interposed between the integrator and the prism sheet to scatter and transmit light having an incident angle of approximately 0 degrees and only to transmit light incident at other angles.

According to another aspect of the present invention, there is provided a projection display comprising: an illumination module; a transmission-type optical modulator for modulating light incident from the illumination module in response to image data; and a projection optical system for projecting light emitted from the transmission-type optical modulator on an enlarged scale. The illumination module comprises: a light guide; at least one light source for projecting light to at least one edge surface of the light guide; and a selective transmission member which transmits light emitted from the light guide having an angle within a predetermined range in which light can be effectively projected by the projection optical system and which reflects light having an emission angle outside of the predetermined range. The light guide propagates light through total internal reflection and comprises an optical angle converter located on at least one of a light emitting surface and a surface opposite the light emitting surface, for changing an angle of light propagation thought the light guide.

According to another aspect of the present invention, there is provided a projection display comprising: an illumination module; a transmission-type optical modulator for modulating light incident from the illumination module in response to image data; and a projection optical system for projecting light emitted from the transmission-type optical modulator on an enlarged scale. The illumination module comprises: a light guide, a light source, and a selective transmission member. Light is propagated through the light guide by total internal reflection. The light guide includes an optical angle converter for changing an angle of light propagating through the light guide. The optical angle converter is located on at least one of a light emitting surface of the light guide and a surface opposite the light emitting surface. The light source projects light to at least one edge surface of the light guide. The selective transmission member transmits light emitted from the light guide having an angle within a predetermined range in which light can be effectively projected by the projection optical system and reflects light having an emission angle outside of the predetermined range.

According to yet another aspect of the present invention, there is provided a projection display comprising: an illumination module; a reflection-type optical modulator, for modulating light incident from the illumination module in response to image data; an illumination optical system, for collecting light incident from the illumination module on the reflection-type optical modulator; and a projection optical system, for projecting light emitted from the reflection-type optical modulator on an enlarged scale. The illumination module comprises: at least one light source; an integrator for guiding light incident from the light source to the reflection-type optical modulator; and a prism sheet on which a pattern of micro prisms, whose apexes are directed toward the optical modulator, is formed. The integrator guides light incident from the light source to the reflection-type optical modulator, and includes an optical angle converter, which changes the propagation angle of light.

### BRIEF DESCRIPTION OF THE DRAWINGS

The above and other features and advantages of the present invention will become more apparent by describing in detail exemplary embodiments thereof with reference to the attached drawings, in which:

FIG. 1 is a schematic diagram illustrating the configuration of a conventional projection display;

FIGS. 2A and 2B are diagrams for explaining light-collecting efficiency of an illumination optical system using lenses;

FIG. 3 is a schematic diagram illustrating the configuration of a projection display according to a first embodiment of the present invention;

FIG. 4 is a cross-sectional view of an illumination module of the projection display in FIG. 3;

FIG. 5 is a graph illustrating a light transmission and reflection property of a dichroic optical system;

FIG. 6 is a cross-sectional view of a modification of the illumination module in FIG. 4;

FIG. 7 is a diagram illustrating the operation of a prism sheet;

FIG. 8 is a graph illustrating a relationship between an incident angle and a transmission angle of a micro prism;

FIG. 9 is a schematic diagram illustrating the configuration of a projection display according to a second embodiment of the present invention;

FIG. 10 is a cross-sectional view of an illumination module of the projection display in FIG. 9; and

FIG. 11 is a cross-sectional view of a modification of the illumination module in FIG. 10.

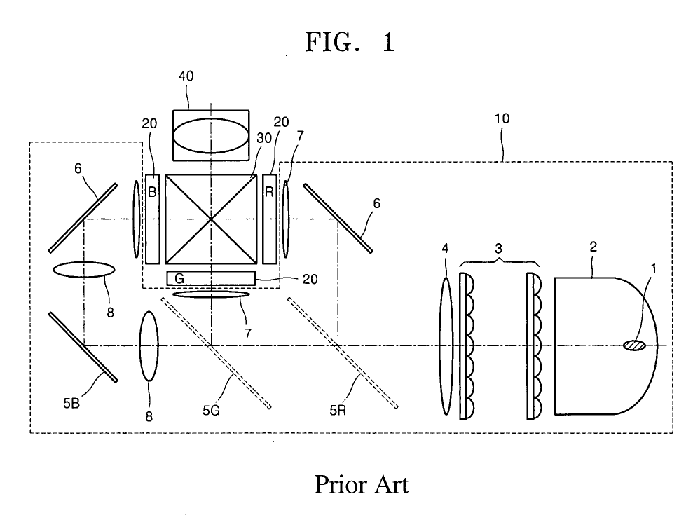

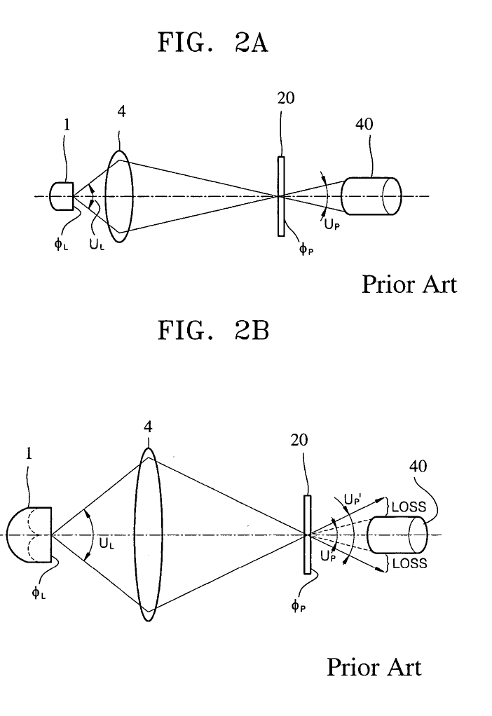

### DETAILED DESCRIPTION OF THE INVENTION

The present invention will now be described more fully with reference to the accompanying drawings, in which illustrative, non-limiting embodiments of the invention are shown.

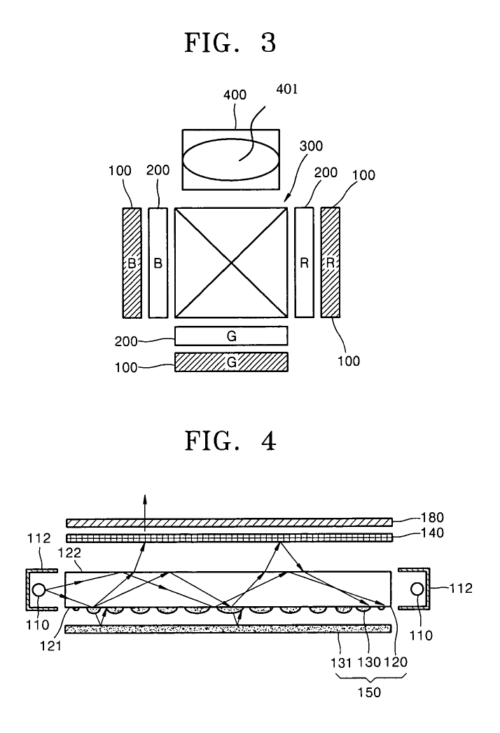

FIG. 3 is a schematic diagram illustrating the configuration of a projection display according to a first embodiment of the present invention. The projection display according to the present embodiment is a color display using a transmission-type optical modulator, which modulates light radiated from an illumination module and outputs the light.

Referring to FIG. 3, a projection display according to a first embodiment of the present invention comprises: liquid crystal panels 200R, 200G, and 200B, which are transmission-type optical modulators: three illumination modules 100, for illuminating the liquid crystal panels 200R, 200G, and 200B: a synthesis prism 300, for synthesizing three colored light beams respectively modulated by the liquid crystal panels 200R, 200G and 200B: and a projection optical system, 400 for projecting synthesized light on an enlarged scale. The three liquid crystal panels 200R, 200G, and 200B respectively modulate three colored light beams, namely, red (R), green (G), and blue (B) colored light beams. The liquid crystal panel used in the projection display may be a small liquid crystal panel approximately 1 inch wide and 1 inch long.

FIG. 4 is a cross-sectional view of an illumination module of the projection display in FIG. 3.

Referring to FIG. 4, the illumination module 100 comprises a light source 110 and a light recycling unit. The light recycling unit comprises an integrator 150 having a light guide 120 and an optical angle converter 130, and a selective transmission member 140. The integrator may also comprise a reflecting plate 131.

Light source 11 may compromise a light emitting diode (LED), an LED array on which a plurality of LEDs are arranged, or an organic electro-luminescence device or the like The light guide 120 guides the propagation of light through total internal reflection. For example, the light guide 120 is configured in the form of a flat panel made of a transparent material. The light source 110 radiates light to at least one edge surface of the light guide 120. While the light source 110 is installed at both edge surfaces of the light guide 120, this is illustrative only and is not intended to limit the scope of the present invention. A reflecting plate 112 may be disposed around the light source 110. The reflecting plate 112 reflects light radiated from the light source 110 to be incident on the light guide 120. Also, the reflecting plate 112 allows light exiting from the light guide 120 to be be reflected back to the light guide 120. An optical angle converter 130 may be located on a bottom surface 121 of the light guide 120 to convert an angle of light propagated to the inside of the light guide 120. The optical angle converter 130 may be a scattering pattern which scatters incident light, or a diffraction pattern which diffracts light. As the optical angle converter 130 gets closer to the light source 110, pattern distribution may be sparser, and as the optical angle converter 130 gets farther from the light source 110, pattern distribution may be denser. The optical angle converter 130 may be disposed on the bottom surface 121 of the light guide 120, or on both the top surface 122 and the bottom surface 121. In the present embodiment, the optical angle converter 130 is located on the bottom surface 121 of the light guide 120. Additionally, a reflecting plate 131 may be disposed below the light guide 120 to reflect light emitted from the bottom surface 121 of the light guide after being scattered or diffracted by the optical angle converter 130 and to allow the light to enter into the light guide 120 again. The reflecting plate 131 reflects light having an incident angle within a predetermined range, and scatters and then reflects light having an incident angle beyond the predetermined range.

The selective transmission member 140 is disposed over the top surface 122 of light guide 120. Of the light emitted from light guide panel 120, the selective transmission member 140 transmits the light travelling within a predetermined emission angle and reflects all other light to be incident on the light guide again. That is to say, the selective transmission member 140 is an optical device capable of selectively reflecting or transmitting light depending on its incident angle. The selective transmission member 140 is one example of an optical angle selector which selectively transmits light having an angle within a predetermined range in which light can be effectively projected by projection lens 401.

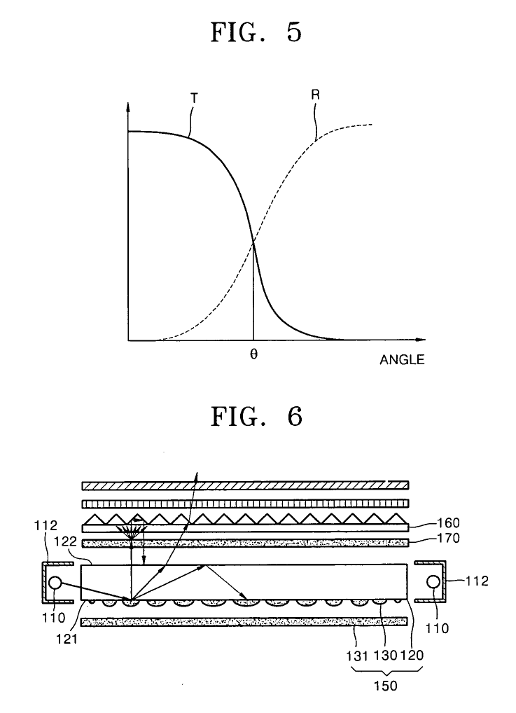

FIG. 5 is a graph illustrating a light transmission and reflection property of the selective transmission member. Referring to FIG. 5, a reflection curve R and a transmission curve T cross each other at a specific incident angle θ. When an incident angle of light incident on the selective transmission member 140 is smaller than the specific incident angle θ, most of the light is transmitted. When an incident angle of light entering into the selective transmission member 140 is larger than the specific incident angle θ, most of the light is reflected. Thus, when the specific incident angle θ is the same as an incident angle of light at which light can be effectively projected by a projection optical system 400, most of the light emitted from the light guide 120, having an angle within the predetermined range in which travelling light can be effectively projected by the projection optical system 400 is passed through the selective transmission member 140, and the rest of the light is reflected back to the light guide 120. When a light emitting diode (LED) radiating white light is used as the light source 110, it is preferable that the selective transmission member 140 with dichroic characteristics may be used to pass one of red-, blue-, or green-colored light beams.

The light recycling unit according to the present embodiment may further include a polarization member 180. The polarization member 180 may be located on an output side of the selective transmission member 140. In general, the liquid crystal panel 200 uses only light that is polarized in a specific direction. The polarization member 180 transmits only some light emitted from the light guide 120 that has a usable polarization direction, and reflects the rest back to the light guide 120.

The operation of the illumination module constructed as above in FIGS. 3-4 will be explained below.

First, light radiated from the light source 110 is incident on an edge surface of the light guide 120. The light is then propagated through light guide 120. Of incident light directed toward the top surface 122 of the light guide 120, light having an incident angle with respect to the top surface 122 larger than a total internal reflection angle of the light guide 120, namely, a critical angle calculated from a refractive index of the light guide 120, is totally internally reflected and accordingly propagated through the inside of the light guide 120. Light having an incident angle smaller than the total internal reflection angle is passed through the light guide panel 120 and accordingly emitted through the top surface 122, which is a light emitting surface of the light guide 120. Light incident on the bottom surface 121 of the light guide 120 is scattered or diffracted by the optical angle converter 130, thereby undergoing changes in a propagation angle thereof. This light is then transmitted through the top surface 122 or is totally internally reflected and propagated through the inside of the light guide 120 depending on its angle of incidence on the top surface 122. Light which has passed through the bottom surface 121 of the light guide 120 is reflected, or is scattered and then is reflected by the reflecting plate 131 to be incident on the inside of the light guide 120 again. In this way, because the propagation angle change and total reflection are repeated, light having an incident angle with respect to the top surface 122 smaller than the critical angle is transmitted through the top surface 122 of the light guide 120 and emitted.

Light emitted from the top surface 122 of the light guide 120 is incident on the selective transmission member 140. Some of the light passes through the selective transmission member 140 and some is reflected according to an incident angle on the selective transmission member 140. According to one configuration of the present embodiment, selective transmission member 140 may comprise a dichroic optical system. With reference to FIG. 5, some light which can be effectively projected by the projection optical system 400 is not passed through the transmission member 140, but is instead reflected. Also, some light which cannot be effectively projected by the projection optical system 400 is passed through the transmission member 140. However, on the whole, the selective transmission member 140 transmits light having an angle within a predetermined range in which light can be effectively projected by the projection optical system 400 and reflects the remaining light.

Light reflected by the dichroic optical system 140 is incident on the light guide 120 again and is internally reflected, so that a propagation angle of the light is changed and thus the light can enter into the selective transmission member 140 again. While this light recycling process is repeated, the percentage of light emitted by the source 110 which is effectively projected by the projection lens 401 becomes almost 100%. Using this system, light radiated from the light source 110 which is not effectively projected by the projection lens 401 is reflected back through the system, such that the amount of light lost is drastically reduced and light-collecting efficiency is enhanced. Thereby, image brightness is also increased.

When the polarization member 180 is provided on an output side of the selective transmission member 140, light polarized in a direction which cannot pass through the liquid crystal panel 200 is reflected back to the light guide 120. The light entering into the light guide 120 again is scattered or diffracted by the optical angle converter 130, such that the direction of polarization of the light changes and thus the light is emitted from the light guide 120 through the light recycling process. In fact, when the polarization member 180 is installed, the amount of light incident on the liquid crystal panel 200 is about 1.6 times as much as when the polarization member 180 is not installed.

FIG. 6 is a cross-sectional view of a modification of the illumination module in FIG. 4. Hereinafter, elements which are the same as those of FIGS. 3 and 4 are given the same reference numerals.

Referring to FIG. 6, a prism sheet 160 is provided as an optical angle selector, and a selective transmission member 140 is further provided on an output side of the prism sheet 160. A polarization member 180 may be further disposed on an output side of the selective transmission member 140. The prism sheet 160, on which a plurality of micro prisms are formed, is located over the light guide 120, and has a refractive larger than the refractive index of air.

FIG. 7 is a diagram illustrating the operation of the prism sheet 160. Referring also to FIG. 6, light emitted from the top surface 122 of the light guide 120 is transmitted through a bottom side 162 of a micro prism 161, and refracted. Since a refractive index of the prism sheet 160 is larger than that of air, a transmission angle θ₂ is smaller than an incident angle θ₁. Light which has travelled inside the micro prism 161 and is transmitted through an oblique side 163 is refracted again. Here, a transmission angle θ₄ with respect to the oblique side is larger than an incident angle θ₃ with respect to the oblique side. Therefore, a transmission angle θ₅ to normal represented by a line 164 is smaller than the incident angle θ₁ to normal. As a consequence, when light emitted from the light guide 120 is passed through the prism sheet 160, the light is collected, so that the amount of light which can be effectively projected by the projection optical system 400 is increased.

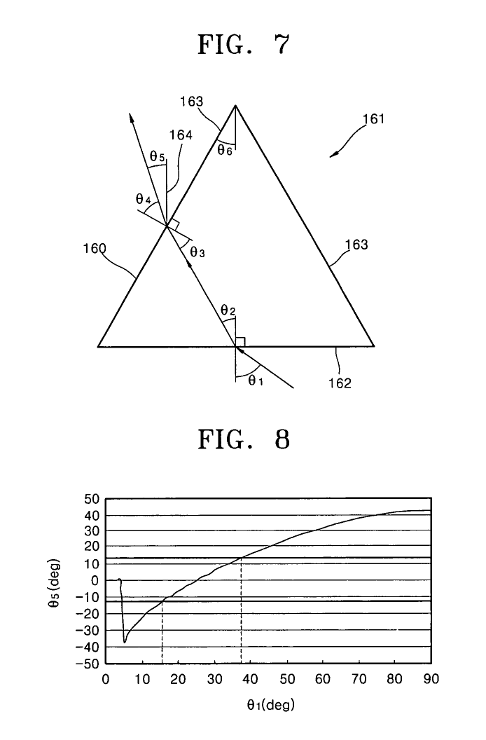

FIG. 8 is a graph illustrating a relationship between an incident angle θ₁ and a transmission angle θ₅ when a vertex angle θ₆ of the micro prism 161 is 45 degrees and the refractive index of micro prism 161 is 1.5. Referring to FIG. 8, light having an incident angle θ₁ ranging from 0 to 5 degrees is totally internally reflected and returned to the light guide 120. At larger incident angles, light generally is transmitted at an angle θ₅ that is reduced relative to the incident angle θ₁. Light returned to the light guide 120 is scattered and diffracted within the light guide, changing its propagation angle. As a result, the light enters into the prism sheet 160 again, repeating the light recycling process. In this way, the amount of light which can be effectively projected by the projection optical system 400 is increased.

When a projection optical system 400 having an F number of 2.5 is used, an effective projection angle is approximately ±12 degrees. Referring to FIG. 8, an incident angle θ₁ of light having a transmission angle θ₅ of approximately 12 degrees is in the range from 15 to 38 degrees.

As shown in FIG. 6, an anisotropic diffusion member 170 functions as an optical angle selector may be interposed between the light guide 120 and the prism sheet 160. The anisotropic diffusion member 170 transmits or scatters light depending on the incident angle of the light. Light incident on the prism sheet 160 at an incident angle θ₁ of about 0 degrees is totally reflected. When the anisotropic diffusion member 170 is installed between the light guide 120 and the prism sheet 160, light emitted from the light guide 120 having an angle of about 0 degrees is scattered and transmitted, and light having a different angle of incidence is transmitted without scattering. In this manner, the amount of light totally reflected from the prism sheet 160 is reduced. As a result, the amount of light which is transmitted through the prism sheet 160 and can be effectively projected by the projection lens 401 is further increased. Actually, when the anisotropic diffusion member 170 is provided, the amount of light which has a transmission angle θ₅ of about ±12 degrees when being passed through the prism sheet 160 is increased about 1.5 times compared to a case where the anisotropic diffusion member 170 is not provided.

While the prism sheet 160 is described as an optical selector, strictly speaking, the prism sheet 160 can function as an optical angle converter as well.

The selective transmission member 140 transmits light through the prism sheet 160 at a transmission angle θ₅ within a range in which light can be effectively projected by the projection optical system 400, and reflects the remaining light to be incident on the light guide 120 again. The light reentering the light guide 120 goes through the above-described light recycling process and is then re-transmitted through prism sheet 160 and is eventually transmitted to selective transmission member 140.

When the polarization member 180 is provided on an output side of the selective transmission member 140, light having a polarization which cannot be transmitted through the liquid crystal panel 200 (see FIG. 3) is reflected and accordingly incident on the light guide 120 again through the light recycling process.

When implementing the illumination module as constructed above, of the total light radiated from the light source, the amount of light which can be effectively projected by the projection lens 401 is further increased when compared with the case where only the selective transmission member 140 is used.

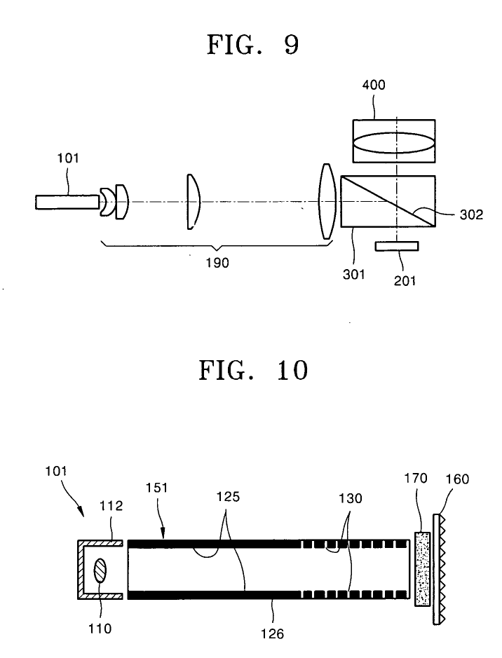

FIG. 9 is a schematic diagram illustrating the configuration of a projection display according to a second embodiment of the present invention. The projection display according to the second embodiment is a color display using a reflection-type optical modulator which modulates light radiated from an illumination module.

Referring to FIG. 9, the projection display according to the present embodiment includes a digital micromirror device (DMD) 201 which is a reflection-type optical modulator, an illumination module 101 for illuminating the DMD 201, an illumination lens array 190 for collecting light emitted by the illumination module 101 to the DMD 201, a total internal reflection (TIR) prism 301, and a projection optical system 400 for projecting light modulated by the DMD 201 on an enlarged scale. The DMD 201 is an example of a reflection-type optical modulator, and may be replaced by a reflection-type liquid crystal panel.

The TIR prism 301 totally reflects light from the illumination module 101 incident on a boundary surface 302, towards the DMD 201, and it transmits reflected light modulated by the DMD 201 through the boundary surface 302 and towards the projection optical system 400.

FIG. 10 is a cross-sectional view of an illumination module of the projection display shown in FIG. 9.

Referring to FIG. 10, the illumination module 101 includes a light source 110 and a light recycling unit. The light recycling unit includes an integrator 151 and a prism sheet 160.

The integrator 151 guides light, and may include a light tunnel 126 in the form of a hollow rectangular pipe at the inner walls thereof, the light tunnel having a light reflecting surface 125. The integrator 151 may further include a light rod (not shown) in the form of a hollow rectangular pipe made of a glass or plastic, which has high light transmissivity, instead of the light tunnel 126.

The light source 110 is installed at one end of the light tunnel 126 to radiate light to the light tunnel 126. A reflecting plate 112 may be located around the light source 110.

An optical angle converter 130 is disposed at the opposite end of the light tunnel 126 to the light source 110. The optical angle converter 130 may be a scattering pattern or a diffraction pattern as described above.

A prism sheet 160 is disposed on an output side of the light tunnel 126. An anisotropic diffusion member 170 may be interposed between the light tunnel 126 and the prism sheet 160 to transmit light as it is or to scatter and then transmit light depending on the incident angle of the light. The prism sheet 160 and the anisotropic diffusion member 170 have been described in FIG. 6, and thus will not be described again.

In the illumination module as constructed above, light radiated from the light source 110 undergoes repeated reflection on the reflecting surfaces 125 such that the light is propagated through the light tunnel 126 and is incident on the optical angle converter 130. Light is scattered or diffracted by the optical angle converter 130, such that the propagation angle of the light changes and the scattered or diffracted light is then incident on the anisotropic diffusion member 170. The anisotropic diffusion member 170 scatters and transmits light having an incident angle of about 0 degrees and just transmits light incident at all other angles. Light which has passed through the anisotropic diffusion member 170 is transmitted to the prism sheet 160 and is directed to the DMD 201 through the illumination lens array 190 and the TIR prism 301. Light modulated by the DMD 201 is transmitted through TIR prism 301 and is projected on an enlarged scale via the projection optical system 400. Light which has not passed through the prism sheet 160 is returned to the light tunnel 126 to undergo a light recycling process and repeat the aforesaid steps. Through the light recycling process, the amount of light which can be effectively projected by the projection optical system 400 is increased compared with that of the conventional projection display.

Light-collecting efficiency achieved when the prism sheet 160 is provided will be explained. When an F number of the projection optical system 400 is 2.4, a size of the DMD 201 is 0.79, an aspect ratio is 16:9, and a resting area of an illuminated area is 5%, etendue at a projection side is 25.1. When an angle of light emitted from the illumination module 101 is approximately 40 degrees and a sectional area of the light tunnel 126 is 4.5 mm×7.8 mm, etendue at the illumination module 101 side is 24.5. These results show that the present embodiment can collect light at a very high efficiency. When the anisotropic diffusion member 170 is also used, the light-collecting efficiency is further improved.

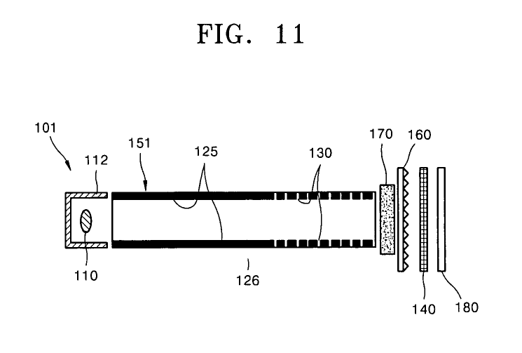

FIG. 11 is a cross-sectional view of a modification of the illumination module shown in FIG. 9. Referring to FIG. 11, a selective transmission member 140 is further provided on an output side of the prism sheet 160. The selective transmission member 140 has been previously described in FIG. 4 and thus will not be described again. According to the illumination module constructed as above, light transmitted through the prism sheet 160 beyond an angle which can be effectively projected by the projection optical system 400 is reflected and goes through a light recycling process. Therefore, the amount of light which can be effectively projected by the projection optical system 400 is further increased. When a reflection-type liquid crystal panel is used as a reflection-type optical modulator, if the polarization member 180 is further provided, the amount of light which can be effectively projected by the projection optical system 400 is increased even more.

While the transmission-type optical modulator and the reflection-type optical modulator are used separately in the aforementioned embodiments, this is illustrative only and is not intended to limit the scope of the present invention. The illumination module 100 can be used both in the projection display using the reflection-type optical modulator shown in FIG. 10 and in the projection display using the transmission-type optical device shown in FIG. 3.

As described above, the projection display according to the present invention has the following effects.

First, of all light radiated from the light source, light which cannot be effectively projected by the projection optical system is recycled through the light recycling process, thereby drastically reducing light loss, improving light-collecting efficiency, and obtaining a brighter image.

Second, a decrease in light-collecting efficiency due to defects of an illumination optical system using lenses is prevented, and accordingly, a small light source, such as an LED, an LED array, an organic electro-luminescence device, or the like, can be used as the light source. Thus, inconvenience of replacing the light source often is reduced.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A projection display comprising:
an illumination module;
an optical modulator for modulating light incident from the illumination module in response to image data; and
a projection optical system for projecting light emitted from the optical modulator on an enlarged scale,
wherein the illumination module comprises:
at least one light source; and
a light recycling unit which causes light emitted from the light source having an emission angle beyond a predetermined range in which light can be effectively projected by the projection optical system to travel within the predetermined range.

2. The projection display of claim 1, wherein the light source includes a light emitting diode.

3. The projection display of claim 2, wherein the light source includes a light emitting diode array on which a plurality of light emitting diodes are arranged.

4. The projection display of claim 1, wherein the light source includes an organic electro-luminescence device.

5. The projection display of claim 1, wherein the light recycling unit includes:
an integrator for guiding light incident from the light source to the optical modulator and including an optical angle converter which changes a propagation angle of light; and
an optical angle selector disposed on an output side of the integrator for selectively transmitting or reflecting light depending on an incident angle of the light.

6. The projection display of claim 5, wherein the integrator includes a light guide in the form of a flat panel through which light propagates by using a total reflection, and the light source projects light to at least one edge surface of the light guide.

7. The projection display of claim 6, wherein the optical angle converter includes a scattering pattern disposed on at least one of a light emitting surface of the light guide and a surface opposite to the light emitting surface.

8. The projection display of claim 6, wherein the optical angle converter includes a diffraction pattern disposed on at least one of the light emitting surface of the light guide and a surface opposite to the light emitting surface.

9. The projection display of claim 5, wherein the integrator includes a light tunnel in the form of a hollow rectangular pipe having a light reflecting surface formed at the inner walls thereof, and the light source radiates light to one end of the light tunnel.

10. The projection display of claim 9, wherein the optical angle converter is located at an end of the light tunnel on the opposite side of the light source.

11. The projection display of claim 5, wherein the integrator includes a light rod in the form of a hollow rectangular pipe made of a transparent material, and the light source radiates light to an end of one side of the light rod.

12. The projection display of claim 11, wherein the optical angle converter is located at an end of the light tunnel on the opposite side of the light source.

13. The projection display of claim 5, wherein the optical angle selector includes a selective transmission member which transmits light emitted from the integrator having an emission angle within a predetermined range in which light can be effectively projected by the projection optical system and reflects light having an emission angle outside of the predetermined range.

14. The projection display of claim 13, wherein the optical angle selector includes a polarization member which transmits only light having a polarization that can pass through the optical modulator and reflects other polarizations, when the optical modulator is a transmission-type optical device which permits only light having a predetermined polarization to pass therethrough.

15. The projection display of claim 14, wherein the polarization member is located on an output side of the selective transmission member.

16. The projection display of claim 13, wherein the optical angle selector further includes a prism sheet on which a pattern of micro prisms whose apex is directed toward the optical modulator is formed.

17. The projection display of claim 16, wherein the prism sheet is interposed between the integrator and the selective transmission member.

18. The projection display of claim 16, wherein the optical angle selector includes an anisotropic diffusion member interposed between the integrator and the prism sheet and adapted to scatter and then transmit light having an incident angle of about 0 degrees and just transmit light incident at other angles.

19. The projection display of claim 5, wherein the optical angle selector includes a prism sheet on which a pattern of micro prisms whose apex is directed toward the optical modulator is formed.

20. The projection display of claim 19, wherein the optical angle selector further includes an anisotropic diffusion member interposed between the integrator and the prism sheet and adapted to scatter and then transmit light having an incident angle of about 0 degrees and just transmit light incident at other angles.

21. The projection display of claim 19, wherein the optical angle selector further includes a polarization member which transmits only light having a polarization which can pass through the optical modulator and reflects other polarizations, when the optical modulator is a transmission-type optical device which permits only light having a predetermined polarization to pass therethrough.

22. A projection display comprising:
an illumination module;
a transmission-type optical modulator for modulating light incident from the illumination module in response to image data; and
a projection optical system for projecting light emitted from the transmission-type optical modulator on an enlarged scale,
wherein the illumination module comprises:
a light guide through which light propagates by a total reflection, and which includes an optical angle converter located on at least one of a light emitting surface thereof and a surface opposite to the light emitting surface, for changing an angle of light propagating through the light guide;
at least one light source for projecting light to at least one edge surface of the light guide; and
a selective transmission member which transmits light emitted from the light guide having an angle within a predetermined range in which light can be effectively projected by the projection optical system and reflects light having an emission angle outside of the predetermined range back to the light guide.

23. The projection display of claim 22, wherein the light source includes a light emitting diode array on which a plurality of light emitting diodes are arranged.

24. The projection display of claim 22, wherein the illumination module further includes a prism sheet on which a pattern of micro prisms whose apex is directed toward the transmission-type optical modulator is formed, the prism sheet being interposed between the light guide and the selective transmission member.

25. The projection display of claim 24, wherein the illumination module further includes an anisotropic diffusion member interposed between the light guide and the prism sheet for scattering and then transmitting light having an incident angle within a total reflection critical angle of the prism sheet and just transmitting light having an incident angle outside the total reflection critical angle.

26. The projection display of claim 22, wherein the illumination module further includes a polarization member disposed on an output side of the selective transmission member for transmitting light having a polarization that can be transmitted through the optical modulator and reflecting other polarizations.

27. A projection display comprising:
an illumination module;
a reflection-type optical modulator for modulating light incident from the illumination module in response to image data;
an illumination optical system for collecting light incident from the illumination module on the reflection-type optical modulator; and
a projection optical system for projecting light emitted from the reflection-type optical modulator on an enlarged scale,
wherein the illumination module comprises:
at least one light source;
an integrator for guiding light incident from a light source to the reflection-type optical modulator and including an optical angle converter which converts a propagation angle of light; and
a prism sheet on which a pattern of micro prisms whose apex is directed toward the optical modulator is formed.

28. The projection display of claim 27, wherein the light source includes a light emitting diode array on which a plurality of light emitting diodes are arranged.

29. The projection display of claim 27, wherein the integrator includes a light tunnel in the form of a hollow rectangular pipe having a light reflecting surface formed at the inner walls thereof, and the light source radiates light to an end of one side of the light tunnel.

30. The projection display of claim 27, wherein the integrator includes a light rod in the form of a hollow rectangular pipe made of a transparent material, and the light source radiates light to an end of one side of the light rod.

31. The projection display of claim 27, wherein the illumination module further includes an anisotropic diffusion member interposed between the integrator and the prism sheet for scattering and then transmitting light having an incident angle within a total reflection critical angle of the prism sheet and just transmitting light having an incident angle outside the total reflection critical angle.

32. The projection display of claim 31, wherein the illumination module further includes a selective transmission member located on an output side of the prism sheet for transmitting light having an angle within a predetermined range in which light can be effectively projected by the projection optical system and reflecting light having an angle outside of the predetermined range back to the integrator.

33. A projection display comprising:
a) a prism;
b) a projection optical system positioned proximate to a first side of said prism;
c) a plurality of liquid crystal panels having a first side and a second side, wherein the first side of the plurality of liquid crystal panels is positioned proximate to opposing sides of the prism;
d) a plurality of illumination modules, positioned proximate to the second side of the plurality of liquid crystal panels, and wherein each one of the plurality of illumination modules comprises:
a light guide;
at least one light source positioned to emit light incident on an end of the light guide;
an optical angle converter disposed on a bottom surface of the light guide;
a reflecting plate positioned proximate to the optical angle converter; and
a selective transmission member positioned proximate to a top surface of the light guide.

34. The projection display according to claim 33, wherein each one of the plurality of illumination modules further comprises:
at least one reflecting plate, each one of the at least one reflecting plates positioned proximate to one of the at least one light source opposite to the light guide, whereby the each one of the at least one reflecting plates reflects light emitted from one of the at least one light sources onto an end of the light guide.

35. The projection display according to claim 33, wherein each one of the at least one light sources comprises a light emitting diode.

36. The projection display according to claim 33, wherein each one of the least one light sources comprises a plurality of light emitting diodes.

37. The projection display according to claim 33, wherein the each one of the plurality of illumination modules further comprises:
a polarization member positioned proximate to the selective transmission member, opposite to the top surface of the light guide.

38. A projection display comprising:
a) a prism;
b) a projection optical system positioned proximate to a first side of the prism;
c) a plurality of liquid crystal panels having a first side and a second side, wherein the first side of the plurality of liquid crystal panels is positioned proximate to opposing sides of the prism;
d) a plurality of illumination modules, positioned proximate to the second side of the plurality of liquid crystal panels, and wherein each one of the plurality of illumination modules comprises:
a light guide;
at least one light source positioned to emit light incident on an end of the light guide;
at least one reflecting plate, each one of the at least one reflecting plates positioned proximate to one of the at least one light source opposite to the light guide, whereby the each one of the at least one reflecting plates reflects light emitted from one of the at least one light source onto an end of the light guide;
an optical angle converter disposed on a bottom surface of the light guide;
a reflecting plate positioned proximate to said optical angle converter;
a selective transmission member positioned proximate to a top surface of the light guide; and
a polarization member positioned proximate to the selective transmission member, opposite to the top surface of the light guide.
